(19) United States
(12) Patent Application Publication
(10) Pub. No.: US 2018/0170726 A1
(43) Pub. Date: Jun. 21, 2018

(54) WINCH CONTROLLER WITH AUTOMATIC SHUT-OFF, AND ASSOCIATED SYSTEMS AND METHODS

(71) Applicant: Superwinch, LLC, Dayville, CT (US)

(72) Inventors: Jacob August, Sherwood, OR (US); Ron Dennis, Woodburn, OR (US); Timothy Frazier, Beaverton, OR (US); Jon Mason, Old Saybrook, CT (US); Scott Salmon, Dayville, CT (US); Ty Hargroder, Los Angeles, CA (US); David Scuito, Molalla, OR (US); David Burns, Wilsonville, OR (US); Brent Nasset, Salem, OR (US)

(21) Appl. No.: 15/793,544

(22) Filed: Oct. 25, 2017

Related U.S. Application Data
(60) Provisional application No. 62/414,915, filed on Oct. 31, 2016.

(51) Int. Cl. B66D 1/48; B66D 1/12; H01H 43/04

(52) U.S. Cl. CPC B66D 1/485; B66D 2700/0141; H01H 43/04; B66D 1/12

(57) ABSTRACT

A winch controller with automatic shut-off, and associated systems and methods are disclosed. A representative winch can include a frame, a cable drum carried by the frame, a drive motor connected to the cable drum, and a winch control module. The control module can include an enable/disable circuit having a normally open ground path connection and a controller having wireless capability. The controller can include instructions to start a shut-off timer when the ground path connection is completed for a non-zero period of time less than a threshold time period and instructions to reset the shut-off timer when the controller receives a control signal from a wireless remote control prior to the shut-off timer expiring. The controller can also include instructions to turn off the controller when the shut-off timer expires prior to receiving a control signal from the remote control or when the ground path is subsequently completed.

### CROSS-REFERENCE TO RELATED APPLICATION

This application claims the benefit of and priority to U.S. Patent Application No. 62/414,915, filed Oct. 31, 2016, the disclosure of which is incorporated herein by reference in its entirety.

### TECHNICAL FIELD

The present technology is directed to winches and, more specifically, to winches with wireless remote control capability, and associated systems and methods.

### BACKGROUND

Winches are typically employed in situations where a vehicle is unable to negotiate an obstacle (e.g., mud or rocks) on its own. For example, a winch is typically used to help extract the vehicle and/or to stabilize the vehicle while negotiating steep terrain. As such, winching operations can involve heavy loads. Therefore, an operator typically employs a remote control to operate the winch while positioned away from the winch and cable.

### BRIEF DESCRIPTION OF THE DRAWINGS

Embodiments of representative winch controllers with automatic shut-off described herein may be better understood by referring to the following Detailed Description in conjunction with the accompanying drawings, in which like reference numerals indicate identical or functionally similar elements:

FIG. 1 is an isometric view of a winch with a dual mode remote control and automatic shut-off according to some embodiments as viewed from the left side;

FIG. 2 is an isometric view of a portion of the winch shown in FIG. 1 as viewed from the right side;

FIG. 3 is an isometric view of the winch shown in FIGS. 1 and 2 with the control module housing removed to illustrate a controller module configured in accordance with some embodiments of the present technology;

FIG. 4 is an isometric view of a remote control connector shown in FIGS. 1 and 2;

FIG. 5 is an electrical schematic of a remote control, in accordance with some embodiments of the present technology;

FIG. 6 is an electrical schematic of an over-ride switch configured in accordance with some embodiments of the present technology;

FIG. 7 is an electrical schematic of a controller module, in accordance with some embodiments of the present technology;

FIG. 8 is a flow chart illustrating an example set of operations for connecting a wired remote control to a winch controller module in accordance with some embodiments of the present technology;

FIG. 9 is a flow chart illustrating an example set of operations for connecting a wireless remote control to the controller module in accordance with some embodiments of the present technology;

FIG. 10 is a flow chart illustrating an example set of operations for connecting a remote control when an over-ride circuit is closed in accordance with some embodiments of the present technology; and

FIG. 11 is a flow chart illustrating an example set of operations for pairing a wireless remote control to the controller module in accordance with some embodiments of the present technology.

The headings provided herein are for convenience only and do not necessarily affect the scope of the embodiments. Further, the drawings have not necessarily been drawn to scale. For example, the dimensions of some of the elements in the Figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all suitable modifications, combinations, equivalents, and/or alternatives of the technology falling within the scope of this disclosure.

### DETAILED DESCRIPTION

### Overview

In some embodiments, the disclosed winches can include a frame, a cable drum rotatably supported by the frame, a drive motor operatively connected to the cable drum, and a control module positioned adjacent the cable drum. The control module can include circuitry to interface with a remote control via one of two modes. In a wireless mode, the control module can communicate wirelessly with a wireless remote control (e.g., a cell phone or dedicated wireless remote). In the wireless mode, the control module's wireless controller continuously scans for signals from a wireless remote control. This can result in a constant battery drain, which after a period of time could discharge a vehicle's battery. The present disclosure provides techniques and technology to automatically shut off the control module. For example, in some embodiments, the control module can include an enable button that turns on the wireless controller module and starts a timer. If an action is not received from the wireless remote control before the timer expires the control module is turned off.

In a wired mode, the control module can communicate with a wired remote control. When the wired remote control is connected to the control module, a jumper wire in the wired remote control's connector completes a ground path circuit in the control module to disable the wireless capability of the control module and cause the control module to send a signal to the wireless remote to turn off. Disabling the wireless capability of the control module when the wired remote control is connected to the winch prevents conflicting commands from a wireless remote control that may be in the vicinity of the winch. When the wired remote control is disconnected, the control module is turned off.

### General Description

Various examples of the devices introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures and/or functions may not be shown or described in detail below so as to avoid unnecessarily obscuring the relevant description.

When configured to operate with a wireless winch remote control, the winch's wireless controller is constantly scanning and looking for a signal from the wireless remote control. This can result in a constant battery drain, which after a period of time can discharge a vehicle's battery. Conventional wireless-enablable winches include a switch to turn the wireless transceiver/controller on and off. However, the operator must remember to shut the switch off or suffer battery drain. The winches with automatic shut-off disclosed herein help prevent battery drain caused by a wireless controller.

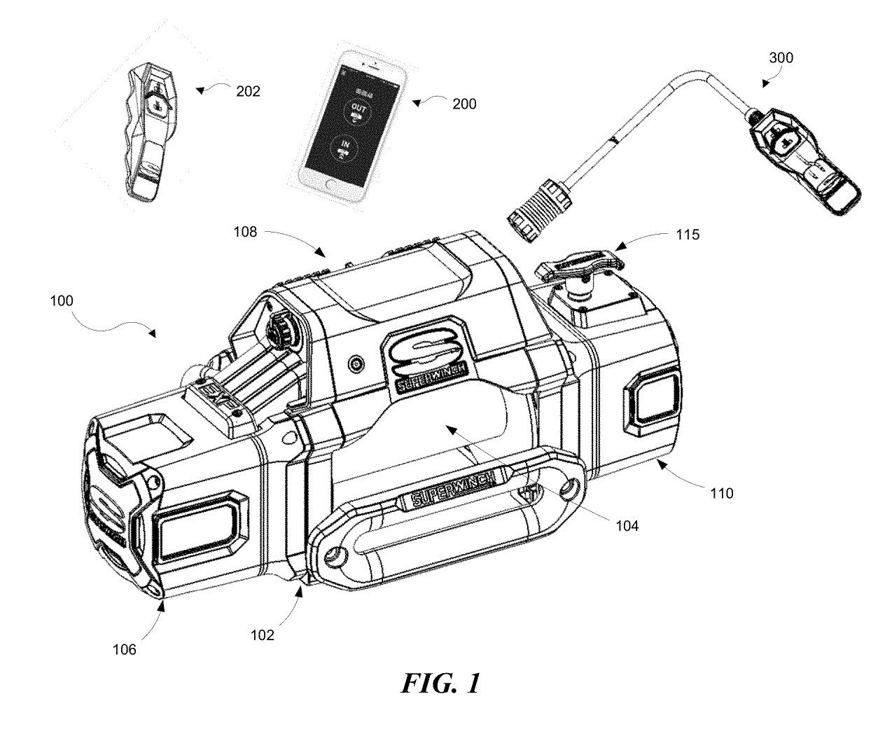

FIG. 1 illustrates a winch 100 having dual mode remote control and automatic shut-off capabilities configured in accordance with some embodiments of the present technology. The winch 100 can include a frame or frame assembly 102 that carries a drive motor 106 which powers a cable drum 104. The drive motor 106 drives the drum 104 through a gear train assembly 110. A clutch mechanism 115 engages and disengages the drum 104 from the gear train assembly 110 to facilitate quickly and easily unwinding the cable from the drum 104. An electrical module, such as a winch control module 108 can span across the cable drum 104 and houses control circuitry for the winch 100.

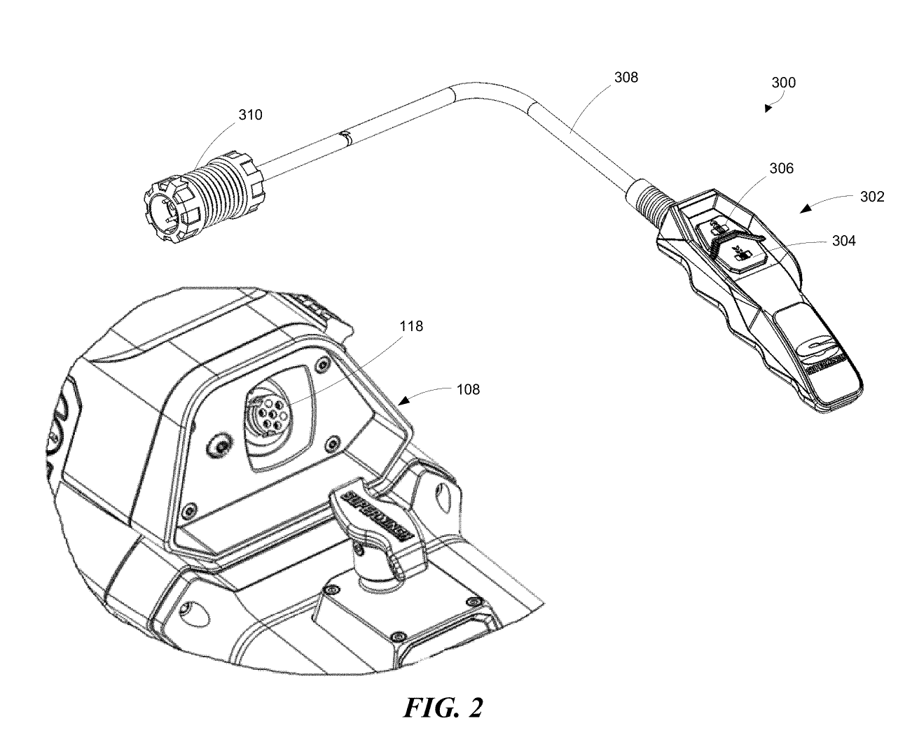

The control module 108 can include circuitry to selectively interface with a remote control via either one of two modes depending on the circumstances. In a wireless mode, the control module 108 can communicate wirelessly with a wireless remote control, such as a cell phone 200 or a dedicated wireless remote 202. In a wired mode, the control module 108 can communicate with a wired remote control 300. With further reference to FIG. 2, the wired remote control 300 can include a housing 302 with winch-in and winch-out buttons 304 and 306, respectively. The wired remote control 300 can include a cable 308 and a remote connector 310. The wired remote control 300 connects to the control module 108 via the remote connector 310 and a mating module connector 118 mounted on the control module 108.

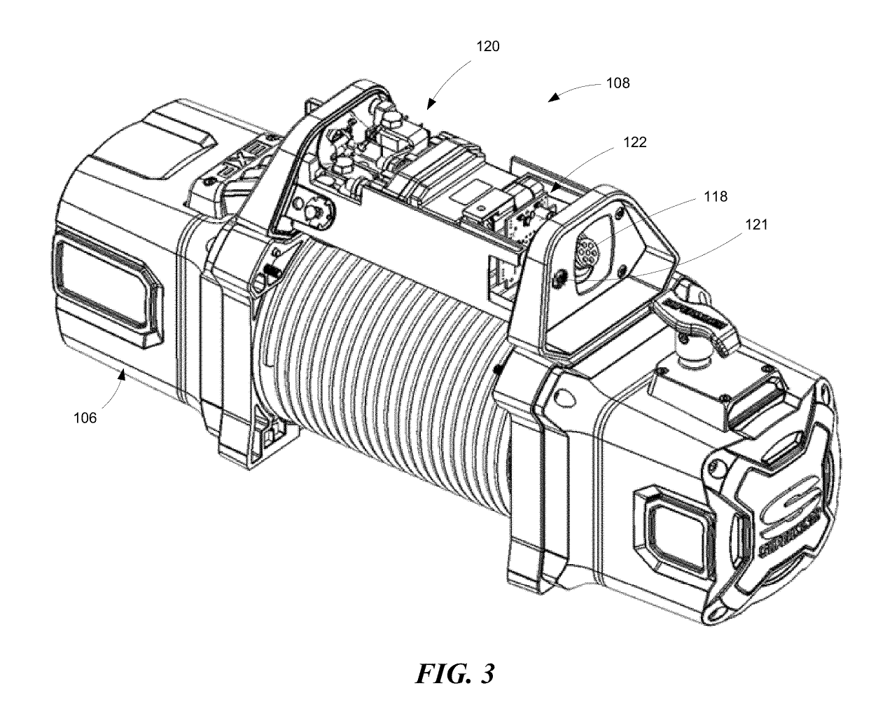

As shown in FIG. 3, the control module 108 can include a contactor module 120 and a controller module 122. Accordingly, the contactor module 120 and the controller module 122 can function as sub-modules of the overall, higher level control module 108. The contactor module 120 can include a switch that directs vehicle battery current to the drive motor 106 (FIG. 1). The contactor module 120 receives signals on low amperage coils from the controller module 122 to switch vehicle battery current to flow in one of two directions (e.g., forward or reverse) to the drive motor 106.

The controller module 122 can operate in either the wireless mode or the wired mode. For example, the controller module 122 can receive a signal from a paired secured transmitter, e.g., the cell phone 200 or wireless remote 202 (FIG. 1), to control the direction of the drive motor 106. Alternatively, the controller module 122 can be connected via the connector 118 to the wired remote control 300 (FIG. 2). The control module 108 can include an enable switch, such as button 121, that facilitates several functions, including turning on the control module 108 in the wireless mode and pairing a wireless remote control to the controller module 122. In some embodiments, the enable button 121 is a momentary push button, or other suitable switch, whereby actuation of the button 121 can send different signals to the controller module 122 determined by the duration of the actuation (i.e., how long the button is pushed).

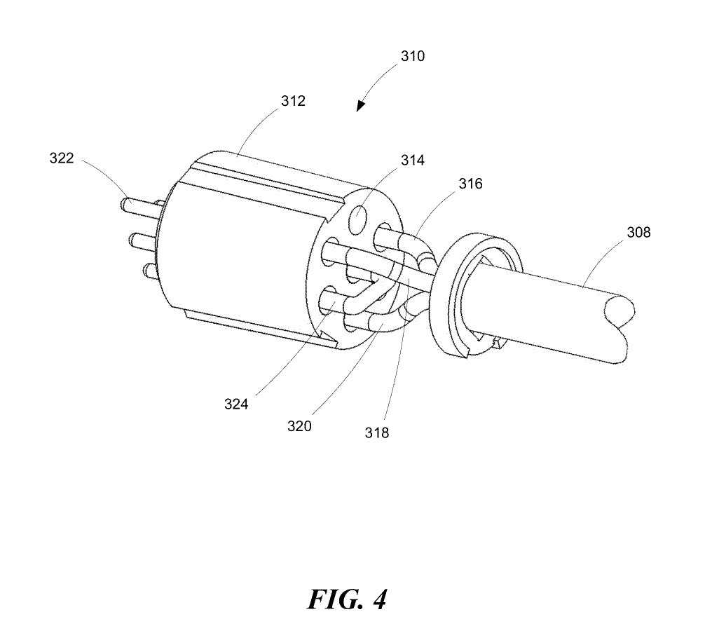

When operating in the wired mode, the connector 118 receives the corresponding remote connector 310 shown in FIG. 2. The remote connector 310 is shown in greater detail in FIG. 4 with the outer housing removed to show the internal components of the connector. The remote connector 310 can include a connector body 312 with a plurality of terminal apertures 314 extending therethrough. The cable 308 can include three control wires 316, 318, and 320 connected at one end to the winch-in and winch-out buttons 304 and 306 (FIG. 2) and connected at the other end to the connector body 312. The control wires 316, 318, and 320 extend into the terminal apertures 314 and connect to corresponding terminals 322. The remote connector 310 can also include a jumper wire 324 which functions to disable the wireless mode when the wired remote control 300 is connected to the controller module 122.

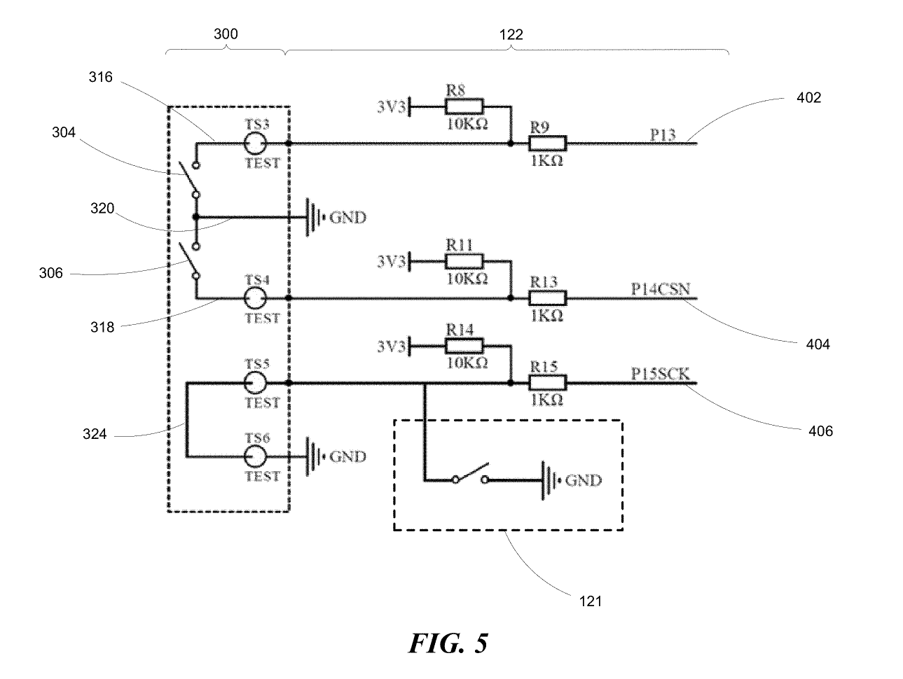

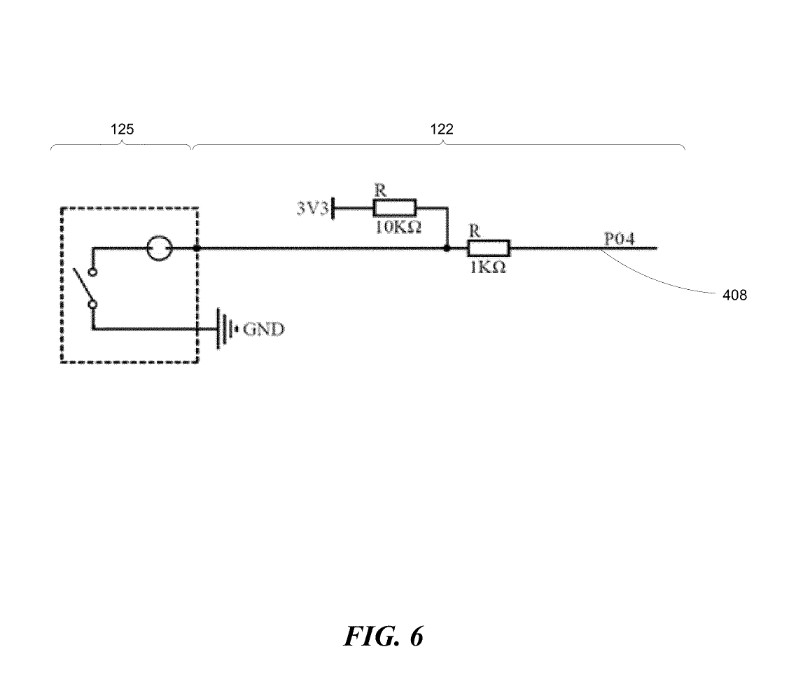

With reference to FIG. 5, when the wired remote control 300 is connected to the controller module 122, the jumper wire 324 completes a ground path connection on an enable/disable circuit 406 thereby pulling the circuit low. Enable switch 121 is also connected to the enable/disable circuit 406. Depending on how long the enable switch 121 is depressed, different functions are activated, as explained more fully below. The control wires 316 and 318 connect to the winch-in and winch-out buttons 304 and 306, respectively. When one or the other of the winch-in and winch-out buttons 304 and 306 are pushed, a ground path is completed, via control wire 320, on a corresponding winch-in circuit 402 or winch-out circuit 404, thereby pulling that circuit low. As shown in FIG. 6, in some embodiments, an over-ride switch 125 can be connected to the controller module 122 that completes a ground path on an over-ride circuit 408. As explained more fully below, the over-ride switch 125 can signal to the controller module 122 to over-ride the automatic shut-off features of the winch.

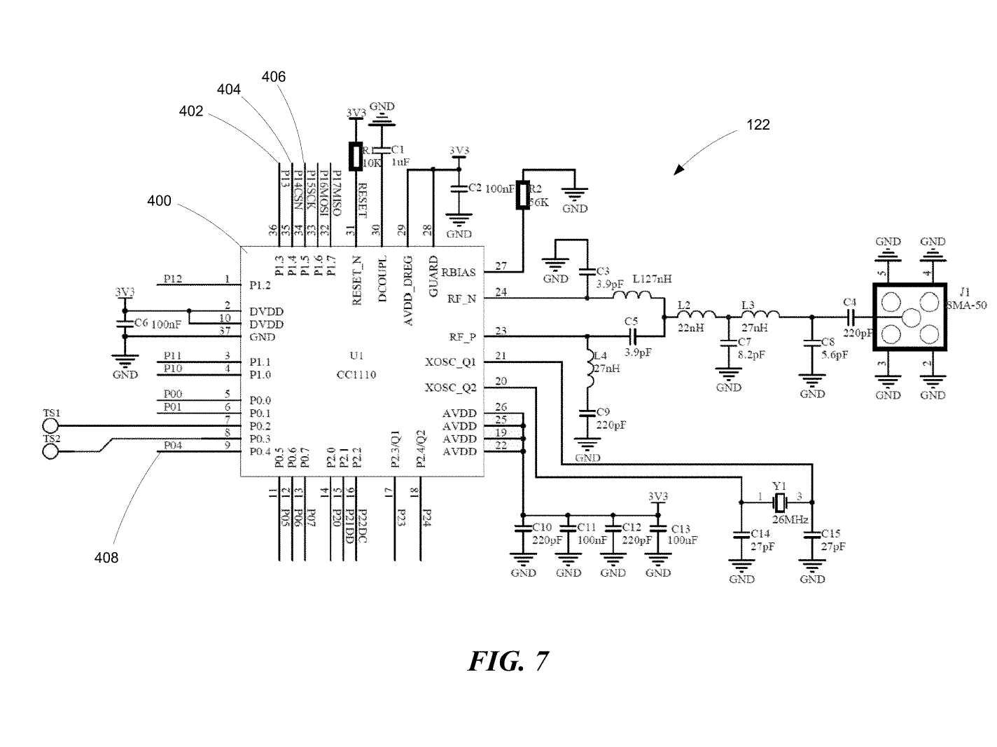

With further reference to FIG. 7, the winch-in, winch-out, enable/disable, over-ride circuits 402, 404, 406, and 408 connect to corresponding control pins P13, P14, P15, and P04 on a controller, such as a wireless-enablable microcontroller 400. When the microcontroller 400 registers a low state on pin P13 or pin P14, the microcontroller 400 directs the contactor module 120 (FIG. 3) to switch vehicle battery current to flow in one of two directions (e.g., forward or reverse) to the drive motor 106 (FIG. 3). When the microcontroller 400 registers a low state on control pin P15, the wireless capability of the microcontroller 400 is disabled. Disabling the wireless capability of microcontroller 400 when the wired remote control 300 is connected to the winch prevents conflicting commands from a wireless remote control that may be in the vicinity of the winch. When the microcontroller 400 registers a low state on control pin P04, the automatic shut-off features are over-ridden. In some embodiments, the controller can be a wireless-enablable system-on-chip microcontroller, such as microcontroller 400. In some embodiments, the controller can include separate processor, memory, and/or wireless transceiver modules, for example.

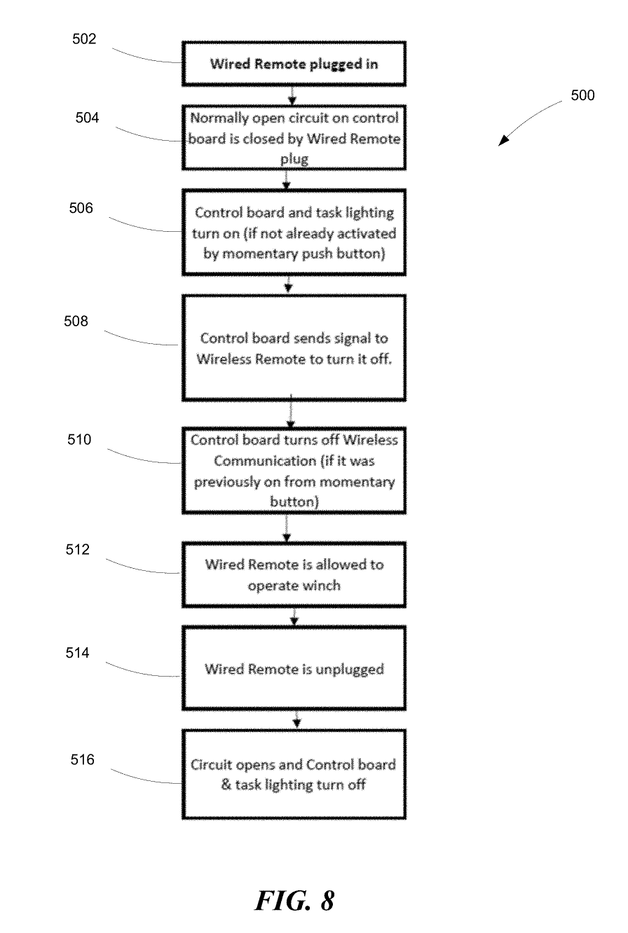

FIG. 8 illustrates a set of operations 500 for connecting the wired remote control 300 to the winch controller module 122 according to some embodiments. When the wired remote 300 is plugged into the control module 108 at operation 502, the normally open control circuit 406 is closed at operation 504. It should be understood that the control circuit is continuously grounded while the wired remote is plugged in. As a result, the controller module 122 is turned on at operation 506. In addition, various lighting (i.e., task lighting) is activated on the winch to indicate that it is operational and to provide illumination for winching operations. The controller module 122, in turn, sends signals to the wireless remote 200/202 to turn off at operation 508. At operation 510 the control module also turns off the wireless communication capability of the controller module 122. At this point in the set of operations 500, the wired remote 300 is functional at operation 512 to control the winch as described above. When the wired remote 300 is unplugged at operation 514, the control circuit 406 is opened and the controller module 122 is turned off at operation 516.

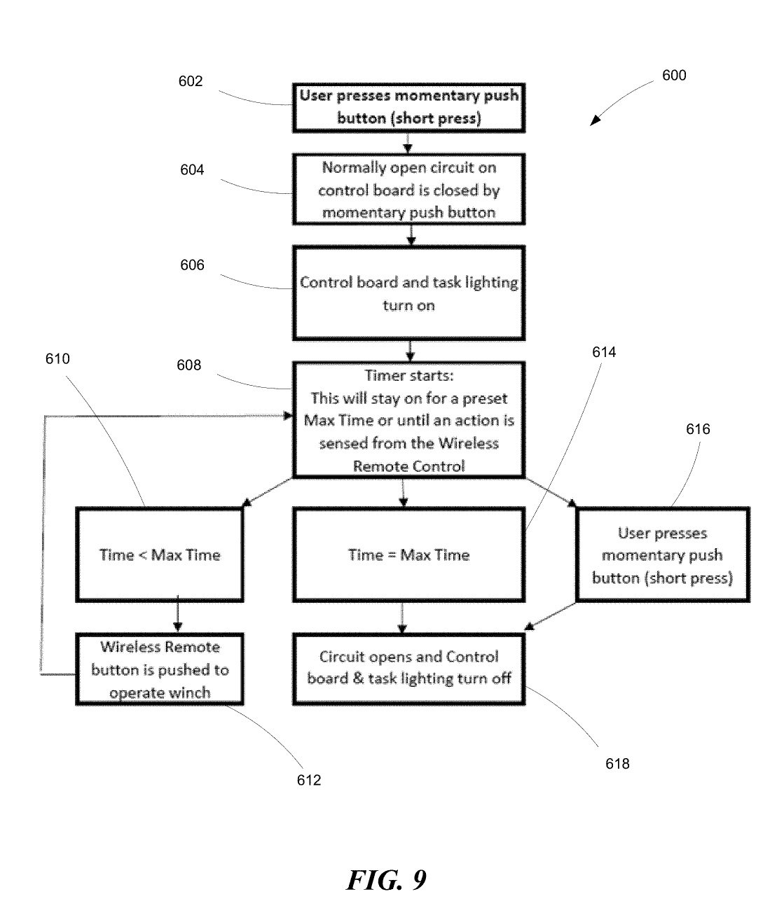

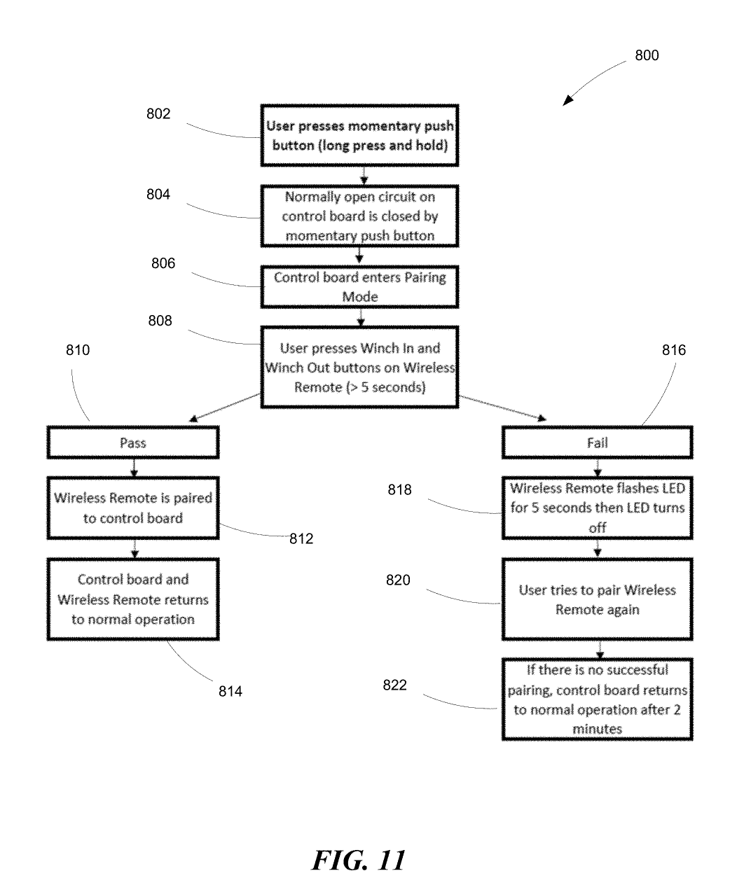

FIG. 9 illustrates a set of operations 600 for connecting the wireless remote control 200/202 to the controller module 122 according to some embodiments. When a user presses and holds the enable button 121 e.g., on the controller module 122, as shown in FIG. 3, for a short period of time (e.g., less than five seconds) at operation 602, the normally open control circuit 406 is closed momentarily at operation 604. Accordingly, the normally open enable/disable circuit 406 (FIG. 5) is completed for a non-zero period of time less than a first threshold time period (e.g., five seconds). This signals the controller module 122 to turn on at operation 606. At operation 608 the controller module 122 starts a timer (e.g., a shut-off timer) that runs for a preset maximum time (e.g., 3-4 hours). In some embodiments, the preset maximum time can be at least approximately one hour. In some embodiments, the timer can be implemented in software and/or hardware. If the timer reaches the maximum time limit at operation 614, the controller module 122 shuts off at operation 618, thereby preventing battery drain. If the user again momentarily presses the enable button 121 at operation 616 for a non-zero period of time less than a second threshold time period (e.g., five seconds), the controller module 122 shuts off at operation 618. If on the other hand, the user presses a button on the wireless remote 200/202 at operation 612 before the timer runs out at operation 610, the timer is restarted at operation 608. A previously paired wireless remote 200/202 can link to the controller module 122 at any time after power up in order to control the winch. The wireless remote 200/202 must have already been paired to the controller module 122 as described below with respect to FIG. 11. In some embodiments, the first and second threshold time periods can be the same. In some embodiments, the first and second threshold time periods can be different.

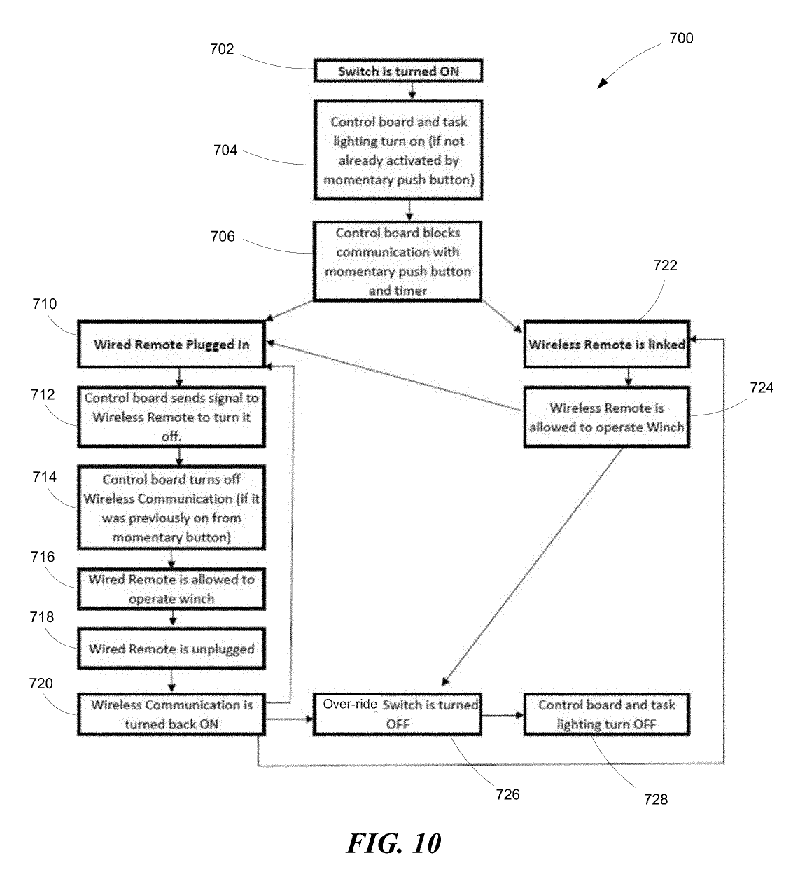

FIG. 10 illustrates a set of operations 700 for connecting a remote control when the over-ride circuit 408 is closed, in accordance with some embodiments. When the over-ride switch 125 is turned on (i.e., closed) at operation 702 the controller module 122 (FIG. 3) turns on at operation 704. The controller module 122 then blocks communication with the enable button 121 (FIG. 3) and disables the timer from operation 608 (FIG. 9) at operation 706. At this point, the wireless remote 200/202 can be linked to the controller module at operation 722 and allowed to operate the winch at operation 724 until the wired remote 300 is plugged into the control module 108 at operation 710 or the over-ride switch 125 is turned off at operation 726. Alternatively, the wired remote 300 can be plugged in at operation 710 at which point the controller module 122 sends signals to the wireless remote 200/202 to turn off at operation 712. At operation 714 the controller module 122 also turns off the wireless communication capability of the controller module 122. At this point in the set of operations 700, the wired remote 300 is functional at operation 716 to control the winch. When the wired remote 300 is unplugged at operation 718, the control circuit 406 is opened and the controller module 122 turns the wireless capability back on at operation 720. The controller module 122 remains on until the over-ride switch 125 is turned off at operation 726 at which point the controller module 122 turns off at operation 728. The over-ride switch is useful in situations where a user wants to operate the winch in a conventional manner with direct control of the power supplied to the controller module 122 rather than rely on the automatic shut-off technology described herein.

FIG. 11 illustrates a set of operations 800 for pairing a wireless remote 200/202 to the controller module 122 according to some embodiments. When a user presses enable button 121 for a long period of time (e.g., greater than five seconds) at operation 802, the normally open control circuit 406 is closed at operation 804. This signals the controller module 122 to enter pairing mode at operation 806. To pair a wireless remote 200/202, the user presses the remote's winch-in and winch-out buttons simultaneously e.g., for at least five seconds at operation 808. If pairing is successful at operation 810, the wireless remote 200/202 is paired with the controller module 122 at operation 812 and the controller module 122 and the wireless remote 200/202 return to normal operation at operation 814. If pairing is unsuccessful at operation 816, the wireless remote 200/212 flashes an indicator (e.g., a light emitting diode) for five seconds at operation 818. At this point, the user can attempt to pair the wireless remote again at operation 820. If pairing is still unsuccessful, at operation 822 the controller module 122 returns to normal operation after a two minute delay period.

In some embodiments, the techniques introduced herein can be embodied as special-purpose hardware (e.g., circuitry), as programmable circuitry appropriately programmed with software and/or firmware, or as a combination of special-purpose and programmable circuitry. Hence, some embodiments may include a machine-readable medium having stored thereon instructions which may be used to program a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. In some embodiments, a suitable wireless-enablable microcontroller can comprise a Texas Instruments CC1110-CC1111 system-on-chip with low-power RF transceiver.

One feature of winches with automatic shut-off having configurations in accordance with embodiments described herein is that the winch can turn itself off after a preset period of time. An advantage of this arrangement is that the winch can automatically shut off to prevent battery drain if a user forgets to otherwise turn off the winch and/or wireless capabilities of the winch.

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

For example, in some embodiments, the shut-off system can be implemented with relays. In some embodiments, the system can include a momentary switch in conjunction with a first normally open relay and a second latching relay. When a user pushes the momentary switch, the two relays are energized. The first relay is normally open, and closes when the momentary switch is pushed. At the same time that battery voltage is applied to the microprocessor via the first relay, the microprocessor sends a pass-through signal through the second relay which in turn supplies a voltage signal through a diode to the first normally open relay. This arrangement holds the first relay closed despite the momentary switch being released. The microprocessor has an internal timer that is started and runs for a prescribed period of time. Once the timer runs out, the microprocessor sends a signal to release its control over the second relay. Once the microprocessor releases control of the second relay and while the momentary switch is not pushed, the first relay opens, thus shutting off power to the microprocessor. In some embodiments, the relays can be micro-relays mounted on a circuit board of the controller module.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not necessarily limited to the various embodiments provided in this specification. Unless otherwise defined, all technical and scientific terms used herein have the same meaning as commonly understood by one of ordinary skill in the art to which this disclosure pertains. In the case of conflict, the present document, including definitions, will control.

In some embodiments, a representative winch controller with automatic shut-off comprises a winch controller module including a wireless-enablable microcontroller and an enable/disable circuit connected to the microcontroller. The winch controller can further include an enable button operative to complete a ground path connection on the enable/disable circuit. The microcontroller can further include instructions operative to start a timer when the ground path connection is completed and to turn off the microcontroller if the timer expires prior to receiving a control signal from a wireless remote control linked to the wireless-enablable microcontroller.

In some embodiments, a representative winch with automatic shut-off comprises a frame, a cable drum carried by the frame, a drive motor operatively connected to the cable drum, and a winch control module. In some embodiments, the control module can include an enable/disable circuit having a normally open ground path connection and a controller having wireless capability connected to the enable/disable circuit. In some embodiments, the controller includes instructions to start a shut-off timer when the ground path connection is completed for a non-zero period of time less than a preselected momentary time period and reset the shut-off timer when the controller receives a control signal from a wireless remote control prior to the shut-off timer expiring. In some embodiments, the controller includes instructions to turn off the controller when the shut-off timer expires prior to receiving a control signal from the wireless remote control or when the ground path connection is subsequently completed for a non-zero period of time less than the preselected momentary time period.

In some embodiments, a representative winch with automatic shut-off comprises a frame, a cable drum carried by the frame, a drive motor operatively connected to the cable drum, and a winch control module. In some embodiments, the winch control module includes an enable/disable circuit having a normally open ground path connection and an over-ride circuit having a normally open ground path connection. In some embodiments, an enable button can be connected to the enable/disable circuit and operative to complete the ground path connection when actuated. A wireless-enablable microcontroller can be connected to the enable/disable circuit and the over-ride circuit. In some embodiments, the microcontroller can include instructions to start a shut-off timer when the ground path connection of the enable/disable circuit is completed for a non-zero period of time less than a preselected momentary time period and reset the shut-off timer when the microcontroller receives a control signal from a wireless remote control linked to the microcontroller prior to the shut-off timer expiring. In some embodiments, the controller includes instructions to turn off the microcontroller when the shut-off timer expires prior to receiving a control signal from the wireless remote control or when the ground path connection of the enable/disable circuit is subsequently completed for a non-zero period of time less than the preselected momentary time period. In some embodiments, the controller includes instructions to disable the shut-off timer while the ground path connection of the over-ride circuit is completed.

In some embodiments, a representative method for automatically shutting-off a winch controller comprises starting a shut-off timer when a normally open ground path connection of an enable/disable circuit is completed for a non-zero period of time less than a preselected momentary time period; resetting the shut-off timer when the winch controller receives a control signal from a wireless remote control prior to the shut-off timer expiring; turning off the winch controller when the shut-off timer expires prior to receiving a control signal from the wireless remote control or when the ground path connection of the enable/disable circuit is subsequently completed for a non-zero period of time less than the preselected momentary time period; and disabling the shut-off timer while a normally open ground path connection of an over-ride circuit is completed.

The following examples provide additional embodiments of the present technology.

### EXAMPLES

1. A winch, comprising:
a frame;
a cable drum carried by the frame;
a drive motor operatively connected to the cable drum; and
a winch control module, including:
   an enable/disable circuit having a normally open ground path connection; and
   a controller having a wireless capability and being connected to the enable/disable circuit, the controller including instructions to:
      start a shut-off timer when the ground path connection is completed for a non-zero period of time less than a first threshold time period;
      reset the shut-off timer when the controller receives a control signal from a wireless remote control prior to the shut-off timer expiring; and
      turn off the controller when the shut-off timer expires prior to receiving a control signal from the wireless remote control or when the ground path connection is subsequently completed for a non-zero period of time less than a second threshold time period.

2. The winch of example 1, further comprising an enable switch connected to the enable/disable circuit and operative to complete the ground path connection when actuated.

3. The winch of example 1 or 2, wherein the enable switch is a momentary push button.

4. The winch of any one of examples 1-3, wherein the controller comprises a wireless-enablable microcontroller.

5. The winch of any one of examples 1-4, wherein the first and second threshold time periods are each approximately five seconds.

6. The winch of any one of examples 1-5, wherein the shut-off timer is configured to expire after at least approximately one hour.

7. The winch of any one of examples 1-6, further comprising an over-ride circuit having a normally open ground path connection connected to the controller, and wherein the controller includes instructions to disable the shut-off timer while the ground path connection of the over-ride circuit is completed.

8. A winch, comprising:
a frame;
a cable drum carried by the frame;
a drive motor operatively connected to the cable drum; and
a winch control module, including:
   an enable/disable circuit having a normally open ground path connection;
   an over-ride circuit having a normally open ground path connection;
   an enable switch connected to the enable/disable circuit and operative to complete the ground path connection when actuated; and
   a wireless-enablable microcontroller connected to the enable/disable circuit and the over-ride circuit, the microcontroller including instructions to:
      start a shut-off timer when the ground path connection of the enable/disable circuit is completed for a non-zero period of time less than a first threshold time period;
      reset the shut-off timer when the microcontroller receives a control signal from a wireless remote control linked to the microcontroller prior to the shut-off timer expiring;
      turn off the microcontroller when the shut-off timer expires prior to receiving a control signal from the wireless remote control or when the ground path connection of the enable/disable circuit is subsequently completed for a non-zero period of time less than a second threshold time period; and
      disable the shut-off timer while the ground path connection of the over-ride circuit is completed.

9. The winch of example 8, wherein the enable switch is a momentary push button.

10. The winch of example 8 or 9, wherein the first and second threshold time periods are each approximately five seconds.

11. The winch of any one of examples 8-10, wherein the shut-off timer is configured to expire after at least approximately one hour.

12. A method for automatically shutting-off a winch controller, the method comprising:
starting a shut-off timer when a normally open ground path connection of an enable/disable circuit is completed for a non-zero period of time less than a first threshold time period;
resetting the shut-off timer when the winch controller receives a control signal from a wireless remote control prior to the shut-off timer expiring;
turning off the winch controller when the shut-off timer expires prior to receiving a control signal from the wireless remote control or when the ground path connection of the enable/disable circuit is subsequently completed for a non-zero period of time less than a second threshold time period; and
disabling the shut-off timer while a normally open ground path connection of an over-ride circuit is completed.

13. The method of example 12, wherein the first and second threshold time periods are each approximately five seconds.

14. The method of example 12 or 13, wherein the shut-off timer is configured to expire after at least approximately one hour.

What is claimed is:

1. A winch, comprising:
a frame;
a cable drum carried by the frame;
a drive motor operatively connected to the cable drum; and
a winch control module, including:
an enable/disable circuit having a normally open ground path connection; and
a controller having a wireless capability and being connected to the enable/disable circuit, the controller including instructions to:
start a shut-off timer when the ground path connection is completed for a non-zero period of time less than a first threshold time period;
reset the shut-off timer when the controller receives a control signal from a wireless remote control prior to the shut-off timer expiring; and
turn off the controller when the shut-off timer expires prior to receiving a control signal from the wireless remote control or when the ground path connection is subsequently completed for a non-zero period of time less than a second threshold time period.

2. The winch of claim 1, further comprising an enable switch connected to the enable/disable circuit and operative to complete the ground path connection when actuated.

3. The winch of claim 2, wherein the enable switch is a momentary push button.

4. The winch of claim 1, wherein the controller comprises a wireless-enablable microcontroller.

5. The winch of claim 1, wherein the first and second threshold time periods are each approximately five seconds.

6. The winch of claim 1, wherein the shut-off timer is configured to expire after at least approximately one hour.

7. The winch of claim 1, further comprising an over-ride circuit having a normally open ground path connection connected to the controller, and wherein the controller includes instructions to disable the shut-off timer while the ground path connection of the over-ride circuit is completed.

8. A winch, comprising:
a frame;
a cable drum carried by the frame;
a drive motor operatively connected to the cable drum; and
a winch control module, including:
an enable/disable circuit having a normally open ground path connection;
an over-ride circuit having a normally open ground path connection;
an enable switch connected to the enable/disable circuit and operative to complete the ground path connection when actuated; and
a wireless-enablable microcontroller connected to the enable/disable circuit and the over-ride circuit, the microcontroller including instructions to:
start a shut-off timer when the ground path connection of the enable/disable circuit is completed for a non-zero period of time less than a first threshold time period;
reset the shut-off timer when the microcontroller receives a control signal from a wireless remote control linked to the microcontroller prior to the shut-off timer expiring;
turn off the microcontroller when the shut-off timer expires prior to receiving a control signal from the wireless remote control or when the ground path connection of the enable/disable circuit is subsequently completed for a non-zero period of time less than a second threshold time period; and
disable the shut-off timer while the ground path connection of the over-ride circuit is completed.

9. The winch of claim 8, wherein the enable switch is a momentary push button.

10. The winch of claim 8, wherein the first and second threshold time periods are each approximately five seconds.

11. The winch of claim 8, wherein the shut-off timer is configured to expire after at least approximately one hour.

12. A method for automatically shutting-off a winch controller, the method comprising:
starting a shut-off timer when a normally open ground path connection of an enable/disable circuit is completed for a non-zero period of time less than a first threshold time period;
resetting the shut-off timer when the winch controller receives a control signal from a wireless remote control prior to the shut-off timer expiring;
turning off the winch controller when the shut-off timer expires prior to receiving a control signal from the wireless remote control or when the ground path connection of the enable/disable circuit is subsequently completed for a non-zero period of time less than a second threshold time period; and
disabling the shut-off timer while a normally open ground path connection of an over-ride circuit is completed.

13. The method of claim 12, wherein the first and second threshold time periods are each approximately five seconds.

14. The method of claim 12, wherein the shut-off timer is configured to expire after at least approximately one hour.
